(19) United States
(12) Patent Application Publication
(10) Pub. No.: US 2025/0162549 A1
(43) Pub. Date: May 22, 2025

(54) ELECTRIC RAILROAD RETARDER

(71) Applicant: Advanced Rail Systems, LLC, Riesel, TX (US)

(72) Inventor: Dilson dos Santos Rodrigues, Hewitt, TX (US)

(73) Assignee: Advanced Rail Systems, LLC, Riesel, TX (US)

(21) Appl. No.: 18/515,566

(22) Filed: Nov. 21, 2023

(51) Int. Cl. B60T 7/12

(52) U.S. Cl. CPC B60T 7/128

(57) ABSTRACT

Embodiments herein disclose an electric railroad retarder having a plurality of retarder modules. A retarder module comprises a gear cam assembly disposed between a first brake unit and a second brake unit. The gear cam assembly comprises a first position arm plate and a second position arm plate that are connected to a cam using a first positioning arm and a second positioning arm. The cam rotates to perform one of: compress a first brake spring, a second brake spring, a third brake spring and a fourth brake spring to hold wheels of a railcar; decompress the first brake spring, the second brake spring, the third brake spring and the fourth brake spring to release the wheels of the railcar; and separate the first position arm plate from a first spring base plate, and the second position arm plate from a second spring base plate to allow insertion of a shim.

### TECHNICAL FIELD

The invention generally relates to railroad technologies, and more particularly to retarders for railroads.

### Problem Statement and History

### Interpretation Considerations

This section describes technical field in detail and discusses problems encountered in the technical field. Therefore, statements in the section are not to be construed as prior art.

### Discussion of History of the Problem

The domain of railroad yard operations is critical for the efficient and safe handling of rail traffic. Integral to these operations is the use of railroad retarders, devices designed to slow down railcars as they are sorted and directed to appropriate tracks. The railroad retarders are essential for maintaining the flow and order within the yard, ensuring that the railcars reach their destinations at controlled speeds. In the same context, a patent U.S. Pat. No. 5,338,525 discloses a skate retarder that uses direct spring and a direct cylinder pulling a spring to release cars, while another patent U.S. Pat. No. 7,140,302 discloses a skate retarder that uses direct spring with levers connected to a hydraulic cylinder that pulls a spring to release the cars.

Current retarders, even while being functional, are not without their mechanical vulnerabilities. These weaknesses manifest as points of failure that can lead to increased life-cycle costs, including maintenance, and operational expenses. The retarder's durability is pivotal, as any malfunction not only incurs additional cost but also poses significant safety risks. Prevalent technologies, as referenced in above publications, employ hydraulics or direct-drive mechanics, for example, and these system have multiple weaknesses and points of failure; additionally, these systems employ large foot-prints that occupy considerable space near and around railroad tracks, posing safety issues. Further, employing these technologies can result in transient overpressures within the hydraulic system, leading to seal damage, safety hazards, and potentially dangerous situations in the yard.

The limitations of the current retarders stem from their mechanical design which does not adequately address the transmission of shock through either a hydraulic or mechanical system. The invention overcomes these limitations.

### SUMMARY

The above objective is solved by a railroad retarder as shown and described throughout the specification.

An electric retarder comprising a plurality of retarder modules is herein disclosed. Each retarder module comprises a first brake unit, a second brake unit and a gear cam assembly disposed between the first brake unit and the second brake unit. The retarder module is adapted to enable train retarding, train passage, or shim insertion, and these three actions are described herein. A first action—a retarding action—(provides the retarder module in a first position) includes receiving a friction force at a first brake shoe and a second brake shoe by wheels of the railcar, whereby the speed of a railcar is reduced and the railcar is stopped due to compression action performed by a first brake spring, a second brake spring, a third brake spring and a fourth brake spring, wherein a first position arm plate and a second position arm plate move forward the first brake spring, the second brake spring, the third brake spring and the fourth brake spring respectively and grasp the wheels of the railcar.

A second action—a passage action—includes decompressing the first brake spring, the second brake spring, the third brake spring and the fourth brake spring which either releases the wheels of a railcar or allow a wheel of a railcar to pass ‘through’ the retarder unimpeded; this retarder module position is called the second position or pass-through position. A third action—shim placement action—includes separating a first spring base plate from the first position arm plate and a second spring base plate from the second position arm plate, thereby forming a first shim gap and a second shim gap respectively to allow insertion of the shim in each of the first shim gap and the second shim gap; this retarder module position is called the third position or the shim position. Of course, the present discussion is merely a Summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings. The term “FIGURE” will be abbreviated as “FIG.” henceforth.

FIG. 1 is a top-down view of an example arrangement of railroad retarder modules (aka “retarder modules”) that together form a uniform electric retarder.

FIG. 2 illustrates a close-up perspective view of a retarder module.

FIG. 3 illustrates a perspective view of the retarder module with a structural top plate removed.

FIG. 4 shows a top-down view of the retarder module with the structural top plate removed and a cam in a first position.

FIG. 5 shows a top-down view of the retarder module showing a cam shaft cover and the cam in a second position.

FIG. 6 illustrates a top-down view of the retarder module showing a cam shaft and the cam in a third position for inserting shims.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### Description of the Drawings, A Preferred Embodiment

The present invention discloses a railroad retarder (aka “electric retarder”) that moves a spring set to a desired position. Because the railroad retarder is electric, it eliminates hazards caused by existing hydraulic systems. For example, the railroad retarder eliminates oil leaking at the yard (which is a hazard to the environment and for the operators and field crew), and eliminates hydraulic hoses and hydraulic power unit between tracks that could cause operators or field crew to fall.

A major disadvantage of existing retarders is how to protect the mechanism which is used to open and close the railroad retarders from the shock caused by the cars hitting brake shoes. The shock can damage the hydraulic cylinders, gear boxes or electric motors, thus reducing the life of the equipment and its capacity to hold the cars. The electric railroad retarder disclosed herein addresses these disadvantages.

### LIST OF REFERENCE NUMERALS

TABLE
List of reference numerals

| Reference numerals | Element's names |
|---|---|
| Top-down view of an electric railroad retarder | 100 |
| Railroad track assembly | 110 |
| Railroad tie | 112 |
| First rail | 114 |
| Second rail | 115 |
| Plurality of retarder modules | 120 |
| Retarder module cover | 122 |
| Retarder nose | 124 |
| Motor | 130 |
| Close-up perspective view of retarder module | 200 |
| First brake shoe | 210 |
| Second brake shoe | 212 |
| First frame spring | 214 |
| Second frame spring | 216 |
| First brake spring | 221 |
| Second brake spring | 223 |
| Third brake spring | 225 |
| Fourth brake spring | 227 |
| Gear cam assembly | 230 |
| First module base plate | 240 |
| Second module base plate | 242 |
| First spring base plate | 250 |
| First position arm plate | 251 |
| Second position arm plate | 252 |
| Second spring base plate | 253 |
| First brake shoe base plate | 260 |
| Second brake shoe base plate | 262 |
| Structural top plate | 290 |
| Structural bottom plate | 291 |
| Retarder module with structural top plate removed | 300 |
| First interior frame spring | 310 |
| Second interior frame spring | 312 |
| Third interior frame spring | 314 |
| Fourth interior frame spring | 316 |
| First positioning arm | 320 |
| First cam bearing shaft | 321 |
| Second positioning arm | 322 |
| Second cam bearing shaft | 323 |
| First cam bearing | 330 |
| Second cam bearing | 332 |
| First arm rest | 340 |
| Second arm rest | 342 |
| Cam shaft (Central shaft) | 350 |
| Top-down view, structural top plate removed | 400 |
| Gear box | 410 |
| Cam | 450 |
| Universal transmission shaft entry | 460 |
| cover plate (universal joint coupler) | |
| Top-down view of the retarder module | 500 |
| showing cam shaft cover and cam in second position | |
| Cam shaft cover | 550 |
| View of Cam shaft in Shim position | 600 |
| First shim gap | 610 |
| Second shim gap | 612 |
| Universal transmission shaft (to next retarder module) | 660 |
| Universal transmission shaft (to next retarder module) | 670 |

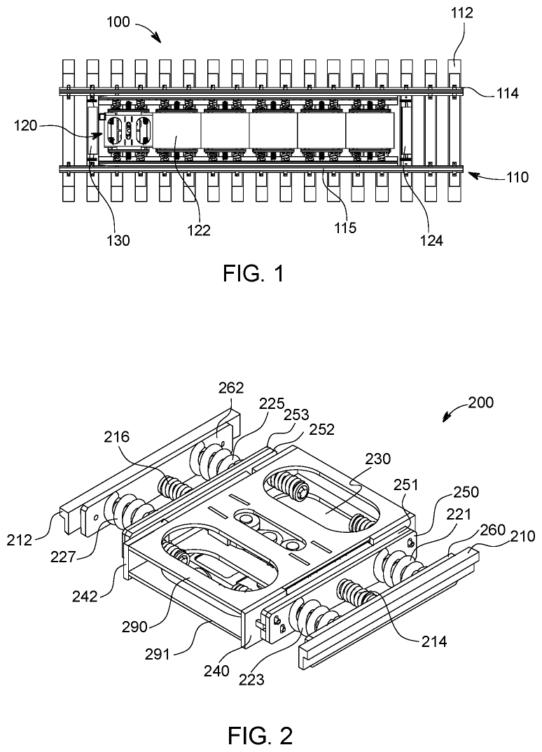

Now referring to FIG. (aka “Figure”) 1, which shows a top-down view of an example arrangement of railroad retarder modules (aka “retarder modules”) that together form a uniform electric retarder 100. Each retarder module and its components may be made of steel, titanium, or other suitable material or combination thereof capable of handing the pressure and force generated by the railcars. FIG. 1 depicts a railroad track assembly 110 having a railroad tie 112 disposed under and between a first rail 114 and a second rail 115 to maintain correct gauge spacing and provide structural support as is well-known in the railroad arts. A plurality of retarder modules 120 (here six are shown) are aligned in series as part of the electric retarder 100. Each retarder module is protected from the elements, critters, and debris via a retarder module cover (“aka protection cover”) 122. Each module 120 has a gear box and a set of springs to control the movement of a railcar (explained in conjunction with FIG. 2 to FIG. 6 in detail). A retarder nose 124 is positioned at each end of the retarder 100 to protect the retarder 100 and a motor (aka “electric gear motor” or “gear motor”) 130 from railroad dragging damage, said damage being well-known to those of ordinary skill in the railroad arts. In an embodiment, the retarder nose 124 is coupled to each of two end-retarder modules, and the motor 130 mechanically couples to each retarder module gear box as disclosed herein. In a preferred embodiment, one motor 130 operates all the gear boxes present in each retarder module as disclosed herein; and in this embodiment retarder modules are interconnected using transmission rods with couplers as disclosed below. In one embodiment, the retarder modules are interconnected using a telescopic universal transmission shaft(s) 660, 670 as shown and described in FIG. 6. While in an alternative embodiment, each retarder module is equipped with its own dedicated motor (not shown) to operate its respective gear box(es).

Further, the preferred arrangement of the railroad retarder modules may have switches (three micro limit switches, for example) (not shown) at a cam shaft of a first retarder module and at a cam shaft of a last retarder module. In a closed (first) position of the retarder modules, a cam will turn/rotate until a third position limit switch is reached. Similarly, in an open (second) position of the retarder modules, the cam will turn until a second position limit switch is reached and, in a shim (third) position, the cam will turn until a first position limit switch is reached. The switches may be installed at the first retarder module and at the last retarder module to ensure that all the gear boxes are moving correctly and are in correct locations for each position. In this scenario, two switches, i.e., the switches at the first retarder module and at the last retarder module must be active at the same time. Alternatively, the switches may be installed at any other suitable location to perform the relevant function for the retarder modules.

Further, the example arrangement of the railroad retarder modules may comprise a processor (aka “microprocessor”) to control the motor 130 and to read the inputs received from the switches to stop the cam at a correct position. The microprocessor may be further configured to diagnose any fault condition.

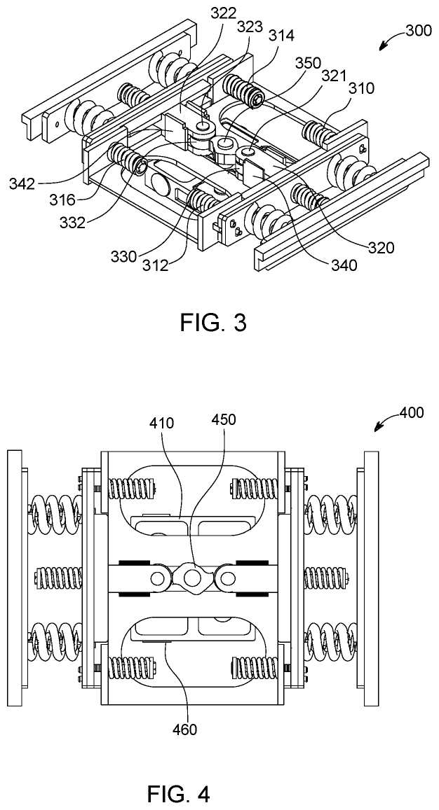

To stop the railcars, the retarder module is preferably in a closed position, also referred to as the first position. This means that brake shoes are positioned to retard the movement of the railcars. The wheels of the railcars in movement through the retarder abut the retarder modules' brake shoes, thus transferring kinetic energy and shock to the set of springs attached thereto. While retarding a railcar, the set of springs is compressed, thus applying their potential energy to wheels (not shown) to reduce the speed of the railcars or other railroad track equipment. To hold the set of springs in the closed position (to retard the car), a central arm assembly (formed by a first positioning arm 320 and a second positioning arm 322, shown in FIG. 3) is coupled to a central shaft (a cam shaft 350, shown in FIG. 3) via a cam (see 450). The central shaft 350 is coupled to a gear box, which is in turn mechanically articulated (moved via rotation) by the motor 130. The cam 450 rotates to increase or decrease pressure on the set of springs as described below.

When in a second pass-through position, the set of springs are pulled into the center of the retarder, which releases forces placed on the wheels of a railcar to avoid retarding the railcar. In a third position, the plates are opened (also called separated). Here a first position arm plate 251 and a first spring base plate 250, and a second position arm plate 252 and a second spring base plate 253 as shown in FIG. 6 to allow the insertion of a shim (not shown, as the use of shims is well known in the railroad arts).

FIG. 2 illustrates a close-up perspective view of a retarder module 200. In general, the retarder module 200 comprises a first brake unit, a second brake unit and a brake spring positioning unit disposed between the first brake unit and the second brake unit.

The first brake unit comprises (or formed by) the first brake shoe 210, a first frame spring 214, a first brake spring 221, a second brake spring 223, the first spring base plate 250, the first position arm plate 251, and a first brake shoe base plate 260. The first frame spring 214, the first brake spring 221, and the second brake spring 223 are disposed in parallel between the first spring base plate 250 and the first brake shoe base plate 260, where the first spring base plate 250 is coupled to the first position arm plate 251 and the first brake shoe base plate 260 is coupled to the first brake shoe 210. It may be noted that the first brake shoe 210, the first frame spring 214, the first brake spring 221, the second brake spring 223, the first spring base plate 250, the first position arm plate 251, and the first brake shoe base plate 260 move collectively as described below. Additionally, as is seen more clearly in FIGS. 4-6, the frame springs are coupled to their respective spring base plates via the first positioning arm 320, described in further detail below, and not to the brake shoe base plates proximate to them.

The second brake unit comprises (or formed by) the second brake shoe 212, a second frame spring 216, a third brake spring 225, a fourth brake spring 227, the second position arm plate 252, the second spring base plate 253, and a second brake shoe base plate 262. The second frame spring 216, the third brake spring 225, and the fourth brake spring 227 are disposed parallelly between the second spring base plate 253, and the second brake shoe base plate 262. The second spring base plate 253 is coupled to the second position arm plate 252 and the second brake shoe base plate 262 is coupled to the second brake shoe 212. It may be noted that the second brake shoe 212, the second frame spring 216, the third brake spring 225, the fourth brake spring 227, the second position arm plate 252, the second spring base plate 253, and the second brake shoe base plate 262 move collectively.

The brake spring positioning unit (aka “a gear cam assembly 230”) comprises a housing having a first module base plate 240, a second module base plate 242, a structural top plate 290 and a structural bottom plate 291. The first module base plate 240 and the second module base plate 242 are positioned vertically, where an outer surface of the first module base plate 240 is coupled to the first position arm plate 251 and an outer surface of the second module base plate 242 is coupled to the second position arm plate 252. The first module base plate 240 and the second module base plate 242 are parallel to each other. Similarly, the structural top plate 290 and the structural bottom plate 291 are positioned (in operation) horizontally and parallel to each other. A first end of the structural top plate 290 is coupled to top of the first module base plate 240 and a first end of the structural bottom plate 291 is coupled to bottom of the first module base plate 240. Similarly, a second end of the structural top plate 290 is coupled to top of the second module base plate 242 and a second end of the structural bottom plate 291 is coupled to bottom of the second module base plate 242. The internal arrangement of the housing of the gear cam assembly 230 is described in further detail below in conjunction with FIG. 3 to FIG. 6.

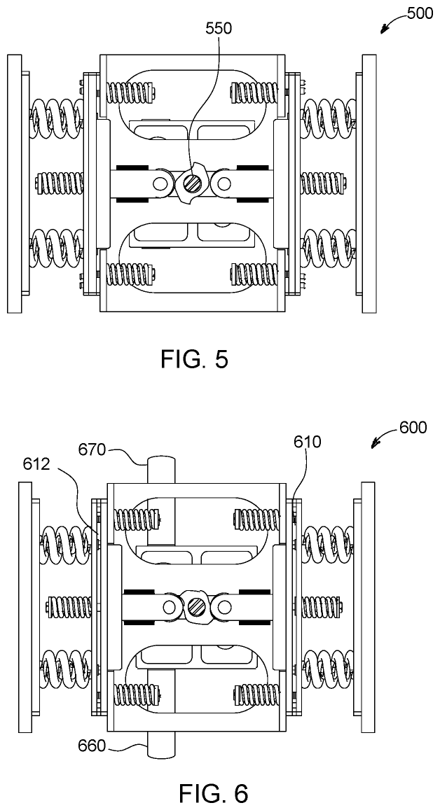

The retarder module 200 is in a closed, brake-active retarding position; and, this position is also shown in FIG. 3 and FIG. 4. When wheels of a railcar transverse (simultaneously) the first brake shoe 210 and the second brake shoe 212, the speed of the railcar is reduced (or stopped) because of the spring compression action of the brank springs 221, 223, 225, 227. The first position arm plate 251 and the second position arm plate 252 provide for movement of their respective springs. The first position arm plate 251 and the second position arm plate 252 are configured to move their respective springs to a desired position. Also, the first position arm plate 251 and the second position arm plate 252 may be pulled towards the cam 450 by the forces of the frame springs 214, 216, thus releasing the wheels of the railcar in an open position (as shown in FIG. 5). Thus, the first position arm plate 251 and the second position arm plate 252 may be said to be coupled to the cam 450 (shown in FIG. 4) via the first positioning arm 320 and the second positioning arm 322 as shown in FIG. 3.

FIG. 3 illustrates a perspective view of the retarder module 300 with the structural top plate 290 removed. From this view, one may see that the housing of the gear cam assembly 230 comprises a first interior frame spring 310, a second interior frame spring 312, a third interior frame spring 314, a fourth interior frame spring 316, the first positioning arm 320 secured via a first cam bearing shaft 321, and a second positioning arm 322 secured via a second cam bearing shaft 323. A first cam bearing 330 is disposed at the head of the first positioning arm 320 and is secured therein by the first cam bearing shaft 321 where a first arm rest 340 reduces lateral movement. Similarly, a second cam bearing 332 is disposed at the head of the second positioning arm 322 and is secured therein by the second cam bearing shaft 323 where a second arm rest 342 reduces lateral movement of the second positioning arm 322. Also shown is the cam shaft 350 which couples the cam 450 to a gearbox.

The first and second interior frame springs 310 and 312 are disposed in the gear cam assembly 230 in parallel and are coupled to an inner surface of the first position arm plate 251. Similarly, the third and fourth interior frame spring 314, 316 are disposed in parallel in the gear cam assembly 230 and are coupled to an inner surface of the second position arm plate 252. This arrangement ensures that when the first brake unit and the second brake unit move, the middle portion of the gear cam assembly 230 remains intact and stationary.

A first end of the first positioning arm 320 is mechanically coupled to the inner surface of the first position arm plate 251 and a second end (head) of the first positioning arm 320 secures the first cam bearing 330 via the first cam bearing shaft 321. The first cam bearing 330 is secured opposite to the inner surface of the first position arm plate 251.

Similarly, a first end of the second positioning arm 322 is mechanically coupled to the inner surface of the second position arm plate 252 and a second end (head) of the second positioning arm 322 secures the second cam bearing 332 via the second cam bearing shaft 323. The second cam bearing 332 is secured opposite to the inner surface of the second position arm plate 252. The arm rests 340, 342 may thus also act as a guiding plate.

The first positioning arm 320 and the second positioning arm 322 are positioned, head-cam-head, in a shared axis and so are mechanically and moveably coupled with the cam 450 (as shown in FIG. 4). Each of the first positioning arm 320 and the second positioning arm 322 may comprise two plates (top and bottom plates) placed in parallel and, when in use, horizontal and separated via the combination of the first cam bearing 330, the cam 450, and the second cam bearing 332. Each cam bearing is manufactured to accommodate 15000 pounds of force, or more.

During operation, the cam 450 absorbs the spring shock transmitted through the first brake shoe base plate 260 and the second brake shoe base plate 262 without damaging the components of the gear cam assembly 230 (including the gear box 410), and the first cam bearing 330 and the second cam bearing 332 rotate following the movement of the cam 450. The first interior frame spring 310, the second interior frame spring 312, the third interior frame spring 314 and the fourth interior frame spring 316 hold the first position arm plate 251 and the second position arm plate 252, respectively; and the first frame spring 214 and the second frame spring 216 hold the first position arm plate 251 and the second position arm plate 252.

FIG. 4 shows a top-down view of the retarder module 400 with the structural top plate removed and the cam 450 in the first position (also called the default, closed or retarding position). Here, the cam 450 is exposing its maximum length (or near maximum length) between the positioning arms 320, 322. In this closed retarding position, when the wheels of a railcar traverse the retarder module brake shoes the first brake spring 221, second brake spring 223, third brake spring 225 and fourth brake spring 227 are compressed and the wheels of the railcar retard, slowing the velocity of the railcar. Stated another way, in this closed retarding position the first position arm plate 251 and the second position arm plate 252 are pushing in the direction of the tracks, and the brake springs 221, 223, 225, 227 impart force through the brake shoes to the wheels of the railcar.

To contrast, when the cam 450 rotates to the open position (as shown in FIG. 5), these brake springs are decompressed, the railcar is released.

FIG. 4 emphasizes the gear box 410, the cam 450. and a universal transmission shaft entry cover plate (aka “universal joint coupler plate”) 460. The cam shaft 350 and the cam 450 are coupled to the gear box 410 such that the gearbox provides the rotational force to change the rotational position of the cam 450. Thus, the cam 450 substantially absorbs the spring shock transmitted through the first position arm plate 251 and the second position arm plate 252, such that the spring shock forces do not damage the gear box 410.

The universal transmission shaft entry cover plate 460, once removed, is utilized to connect the retarder module to a motor (such as the motor 130) or to interconnect other railroad retarders modules 120 (as shown in FIG. 1) using one or more telescopic universal transmission shaft(s) 660, 670 as shown in FIG. 6.

FIG. 5 shows a top-down view of the retarder module 500 showing a cam shaft cover 550 and the cam 450 in a second position (i.e., open position).

The cam 450 may be made of steel or any other suitable material known in the art. As shown in FIG. 4, the cam 450 has a special design to allow the first positioning arm 320 and the second positioning arm 322 to move to two or more rotational positions (aka “stages”). In this second/open position shown in FIG. 4, the cam 450 is rotated to an intermediate radius, allowing the first positioning arm 320 and the second positioning arm 322 to move towards the cam 450 itself. This allows the brake springs 221, 223, 225, 227 to decompress, and for the wheels of a railcar to pass through the retarder without being slowed.

FIG. 6 illustrates a top-down view of the retarder module 600 showing the cam shaft 350 and cam 450 in a third position (i.e., shim position) for inserting shims. In this third shim position shown in FIG. 6, the cam 450 is rotated to a minimum radius, allowing the first positioning arm 320 and the second positioning arm 322 to move towards the cam 450 far enough to create separation between plate pairs 250, 251 and 252, 253, through which a shim may be inserted.

In the third position, the first position arm plate 251 is separated from the first spring base plate 250 and the second position arm plate 252 is separated from the second spring base plate 253 and hence a shim gap, i.e., a first shim gap 610 and a second shim gap 612 are formed respectively, wherein the shim can be inserted. Herein, the first frame spring 214 and the second frame spring 216 are compressed and decompressed to form the shim gap and to allow insertion of the shim. Shims, as is known in the railroad arts, serve as spacers, filling gaps in parts prone to wear. For example, as the first brake shoe 210 and the second brake shoe 212 (as shown in FIG. 2) wear out and lose thickness, a shim may be used to compensate for the thickness lost by these parts. After a shim is inserted, the retarder module may resume normal operation.

The universal transmission shaft 660, 670 are telescopic universal transmission shafts and are utilized in other contexts in the mechanical arts.

It should be noted that although the present invention shows various elements of the retarder module, but it is to be understood that other alternatives are not limited thereon. Further, the labels or names of the elements/components are used only for illustrative purpose and do not limit the scope of the present invention. The shape and size of the various elements in the retarder module do not limit the scope of the present invention.

Unless otherwise defined, all technical and scientific terms used herein have the same meaning as commonly understood by one of ordinary skill in the art to which this invention belongs. Although systems, methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

What is claimed is:

1. A retarder module, comprising:
a first brake unit, the first brake unit comprises:
a first brake shoe, a first frame spring, a first brake spring, a second brake spring, a first spring base plate, a first position arm plate, and a first brake shoe base plate,
wherein the first frame spring, the first brake spring, and the second brake spring are disposed parallelly between the first spring base plate and the first brake shoe base plate,
wherein the first spring base plate is coupled to the first position arm plate and the first brake shoe base plate is coupled to the first brake shoe;
a second brake unit, the second brake unit comprises:
a second brake shoe, a second frame spring, a third brake spring, a fourth brake spring, a second spring base plate, a second position arm plate, and a second brake shoe base plate,
wherein the second frame spring, the third brake spring, and the fourth brake spring are disposed parallelly between the second spring base plate, and the second brake shoe base plate,
wherein the second spring base plate is coupled to the second position arm plate and the second brake shoe base plate is coupled to the second brake shoe; and
a gear cam assembly disposed between the first brake unit and the second brake unit, the gear cam assembly comprises a housing, the housing comprises:
a first module base plate, a second module base plate, a structural top plate and a structural bottom plate, a first interior frame spring, a second interior frame spring, a third interior frame spring, a fourth interior frame spring, a first cam bearing shaft, a second cam bearing shaft, a first cam bearing, a second cam bearing, a first arm rest, a second arm rest and a cam shaft,
wherein an outer surface of the first module base plate is coupled to the first position arm plate and an outer surface of the second module base plate is coupled to the second position arm plate,
wherein the first position arm plate and the second position arm plate are connected to a cam using a first positioning arm and a second positioning arm respectively, the cam rotates to perform one of:
compress the first brake spring, the second brake spring, the third brake spring and the fourth brake spring to hold wheels of a railcar;
decompress the first brake spring, the second brake spring, the third brake spring and the fourth brake spring to release the wheels of the railcar; and
separate the first position arm plate from the first spring base plate, and the second position arm plate from the second spring base plate to allow insertion of a shim.

2. The retarder module of claim 1 wherein
the first brake shoe, the first frame spring, the first brake spring, the second brake spring, the first spring base plate, the first position arm plate, and the first brake shoe base plate move collectively; and
the second brake shoe, the second frame spring, the third brake spring, the fourth brake spring, the second spring base plate, the second position arm plate, and the second brake shoe base plate move collectively.

3. The retarder module of claim 1 wherein the first module base plate and the second module base plate are positioned vertically and are parallel to each other.

4. The retarder module of claim 1 wherein the structural top plate and the structural bottom plate are positioned horizontally and parallel to each other.

5. The retarder module of claim 1 wherein
a first end of the structural top plate is coupled to top of the first module base plate and a second end of the structural top plate is coupled to top of the second module base plate, and
a first end of the structural bottom plate is coupled to bottom of the first module base plate, and a second end of the structural bottom plate is coupled to bottom of the second module base plate.

6. The retarder module of claim 1 wherein when the retarder module is in a closed position, and when a friction force is received at the first brake shoe and the second brake shoe by the wheels of the railcar, the speed of the railcar is reduced and the railcar is stopped due to spring compression action performed by the first brake spring, the second brake spring, the third brake spring and the fourth brake spring.

7. The retarder module of claim 6 wherein a first position arm plate and a second position arm plate move forward the first brake spring, the second brake spring, the third brake spring and the fourth brake spring respectively and hold the wheels of the railcar.

8. The retarder module of claim 1 wherein the first position arm plate is responsible for the movement of the first brake spring and the second brake spring and the second position arm plate is responsible for the movement of the third brake spring and the fourth brake spring.

9. The retarder module of claim 1 wherein
the first interior frame spring, and the second interior frame spring are disposed in the gear cam assembly parallelly and are coupled to an inner surface of the first position arm plate,
the third interior frame spring and the fourth interior frame spring are disposed in the gear cam assembly parallelly and are coupled to an inner surface of the second position arm plate.

10. The retarder module of claim 1 wherein
a first end of the first positioning arm is coupled to an inner surface of the first position arm plate and a second end of the first positioning arm secures the first cam bearing via the first cam bearing shaft,
the first cam bearing is secured opposite to an inner surface of the first position arm plate,
the first positioning arm is disposed within the first arm rest,
a first end of the second positioning arm is coupled to an inner surface of the second position arm plate and a second end of the second positioning arm secures the second cam bearing via the second cam bearing shaft,
the second cam bearing is secured opposite to an inner surface of the second position arm plate, and
the second positioning arm is disposed within the second arm rest.

11. The retarder module of claim 1 wherein the first positioning arm and the second positioning arm are disposed at a center of the gear cam assembly in a shared axis and are in mechanical connection with the cam secured by the cam shaft.

12. The retarder module of claim 1 wherein the cam absorbs spring shock transmitted through the first brake shoe base plate and the second brake shoe base plate without damaging components of the gear cam assembly.

13. The retarder module of claim 1 wherein the first cam bearing and the second cam bearing rotates following the movement of the cam.

14. The retarder module of claim 1 wherein the first frame spring and the second frame spring hold the first position arm plate and the second position arm plate, respectively, connected with the cam all the time.

15. The retarder module of claim 1 wherein the gear cam assembly further comprises a gear box and a universal transmission shaft entry cover plate, wherein the universal transmission shaft entry cover plate, once removed, is utilized to interconnect other railroad retarder modules using a telescopic universal transmission shaft.

16. The retarder module of claim 1 wherein in a second position, the first brake spring, the second brake spring, the third brake spring and the fourth brake spring are decompressed, and the wheels of the railcar be released.

17. The retarder module of claim 1 wherein in a third position, the first position arm plate is separated from the first spring base plate and the second position arm plate is separated from the second spring base plate, thereby forming a first shim gap and a second shim gap respectively to allow insertion of the shim in each of the first shim gap and the second shim gap.

18. A retarder module to control a movement of a railcar by performing at least one of:
receiving a friction force at a first brake shoe and a second brake shoe by wheels of the railcar, whereby the speed of the railcar is reduced and the railcar is stopped due to compression action performed by a first brake spring, a second brake spring, a third brake spring and a fourth brake spring, wherein a first position arm plate and a second position arm plate move forward the first brake spring, the second brake spring, the third brake spring and the fourth brake spring respectively and hold the wheels of the railcar, wherein the retarder module is in a first position;
decompressing the first brake spring, the second brake spring, the third brake spring and the fourth brake spring and releasing the wheels of the railcar, wherein the retarder module is in a second position; and
separating a first spring base plate from the first position arm plate and a second spring base plate from the second position arm plate, thereby forming a first shim gap and a second shim gap respectively to allow insertion of the shim in each of the first shim gap and the second shim gap, wherein the retarder module is in a third position.
